(19) United States
(12) Patent Application Publication
(10) Pub. No.: US 2007/0189553 A1
(43) Pub. Date: Aug. 16, 2007

(54) Cylindrically shaped stage monitor

(76) Inventor: Albert J. Holden III, Bristol, PA (US)

Correspondence Address: Galasso & Associates LP, P.O. Box 26503, Austin, TX, 78755-0503, US

(21) Appl. No.: 11/351,986

(22) Filed: Feb. 10, 2006

(51) Int. Cl. H04R 29/00

(52) U.S. Cl. 381/99; 381/56

(57) ABSTRACT

An aesthetically pleasing stage monitor system is provided. Such a stage monitor system can include a drum frame having mounts that can allow for a stand to hold the stage monitor in a desired position. Inside of the drum frame, a woofer, a tweeter and electronic components can be mounted. A bulkhead connector can be placed on the drum frame to accept an audio signal and power for the stage monitor. On the circular end of the drum frame, a gill can be mounted to protect the woofer and tweeter and keep foreign material from damaging or impairing the performance of the stage monitor. The electronic components can include a crossover module to enhance the quality of sound that the monitor can produce by selectively sending signals to the woofer and the tweeter.

### FIELD OF THE DISCLOSURE

The present disclosure is generally related to a stage based monitoring system and more particularly to a drum set based stage monitor that can placed into a cylindrical housing to integrated with a drum set.

### BACKGROUND

The live music industry and the sale of recorded music both continue to thrive. When musicians are playing to a live audience or in a recording studio it is important for the musicians to hear how they are playing in real-time during such a process. Thus, if a musician is slightly off tune or out of sync they can detect such a problem and correct themselves. A musician can be provided with such audio feedback by utilizing a monitor system that usually includes an amplifier and a speaker that is placed close to the musician. Placement of the monitor is important because it should be placed close to the musician but not so close as to provide undesirable feedback into the musician's microphone. Such monitor systems are typically bulky and can detract from the aesthetics of a stage setting. Accordingly, it would be desirable to musicians and particularly to a drummer to have a stage monitor that is portable, easy to locate near a musician and esthetically pleasing.

### BRIEF DESCRIPTION OF THE DRAWINGS

FIG. 1 is an orthogonal view of a cylindrically shaped stage monitor; and

FIG. 2 is a cut away view of the cylindrically shaped stage monitor.

### DETAILED DESCRIPTION OF THE DRAWINGS

An aesthetically pleasing stage monitor system is provided. Such a stage monitor system can include a drum frame having mounts that can allow for a stand to hold the stage monitor in a desired position. Inside of the drum frame, a woofer, a tweeter and electronic components can be mounted. A bulkhead connector can be placed on the drum frame to accept an audio signal and power for the stage monitor. On one end of the drum frame, a gill can be mounted to protect the woofer and tweeter (the speakers) and keep foreign material from damaging or impairing the performance of the speakers. The electronic components can include a crossover module to enhance the quality of sound that the monitor can produce by selectively sending signals to the woofer and the tweeter.

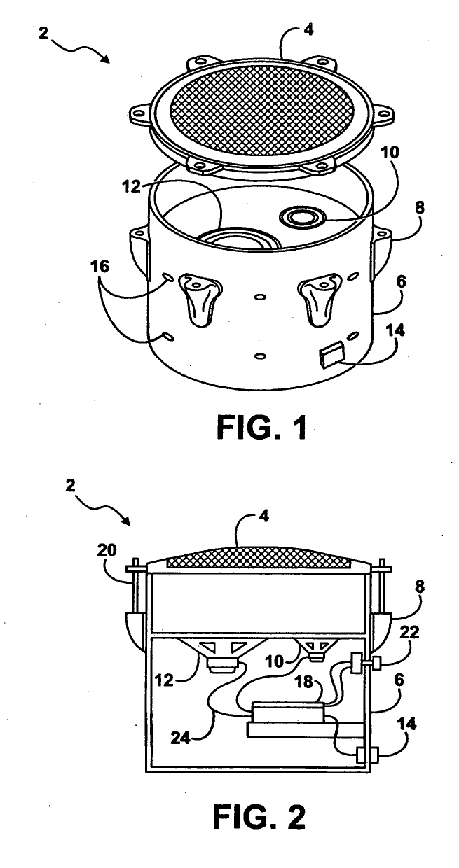

Referring to FIG. 1, a stage monitor 2 integrated into a cylindrical frame 6 is illustrated. The cylindrical frame 6 can be in the shape of, and have features that make it appear as, a functional drum. The cylindrical frame 6 can be manufactured in any size such as a snare drum, a base drum, kettle drum etc. The stage monitor 2 can include a smaller speaker such as a tweeter 10, and a larger speaker such as a woofer 12. The stage monitor could also have a sub-woofer (not shown).

A plug 14 could be secured to the cylindrical frame 6 such that an audio signal and possibly power could be provided to the stage monitor 2. Wires can connect the plug 14 to a “crossover” and possibly an amplifier and a volume control knob in the stage monitor (not shown). The crossover can split the audio signal into two signals wherein higher frequency signals can be sent to the tweeter 10 and lower frequency signals can be sent to the woofer 12. A crossover can improve the performance and efficiency of the stage monitor 2.

The stage monitor 2 can have mounts 8 for mounting a grill 4, and mounts 16 for affixing a stand to the stage monitor 2. A stand (not shown) could be utilized to secure cylindrical frame 6 at a position above the ground or above the stage by fastening the stand to the cylindrical frame 6 via mounts 16. The stand could be a snare stand or a tom-tom stand. In a specific embodiment a stand with a Cooris bonding bracket or Cooris compatible brackets can be utilized.

Referring to FIG. 2 a cut away view of a stage monitor 2 that is configured as a horizontal drum is illustrated. As described with reference to FIG. 1, the stage monitor 2 can have a cylindrical frame 6, that includes grill mounts 8 to mount grill 4. Grill 4 can be secured to the cylindrical frame 6 with threaded members 20. A tweeter 10, a woofer 12, and electronic components 18 can be mounted inside of the cylindrical flame 6.

The stage monitor 2 can include active or passive electronic components 18. For example, electronic components 18 can include a passive or active crossover, an equalizer, an amplifier or any combination thereof and control switches represented by control switch 22. In a specific embodiment, a control switch 22 such as an “ON/OFF,” a volume control, an equalizer, or other type of switch can be mounted on the cylindrical frame 6. The control switch 22 can control operational aspects of the stage monitor 2.

In a specific embodiment a plug 14 such as a bulkhead plug can be mounted that traverses the cylindrical frame 6. Pins or receptacles in plug 14 can be connected via wires 24 to the electronic components 18, the control switch 22, the woofer 12 and the tweeter 10.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A stage monitor comprising:
a cylindrical frame;
a tweeter mounted on the inside of the cylindrical frame;
a woofer mounted on the inside of the cylindrical frame;
a crossover mounted on the inside of the cylindrical frame;
a grill mounted to the cylindrical frame; and
a plug mounted on the cylindrical frame and coupled to the crossover the tweeter and the woofer.

2. The stage monitor of claim 1 wherein the grill is a circular shaped grill.

3. The stage monitor of claim 1 wherein the plug is coupled to wires that interconnect the plug with the woofer and the tweeter.

4. The stage monitor of claim 1 wherein the plug is coupled to wires that interconnect the plug with a crossover.

5. The stage monitor of claim 1 wherein the plug is coupled to wires that interconnect the plug to a switch.

6. The stage monitor of claim 1 wherein the cylindrical frame further comprises a plurality of mounts and wherein a plurality of threaded members connect the grill to the plurality of mounts.

7. The stage monitor of claim 1 further comprising mounting holes on the cylindrical frame configured to secure a stand to the cylindrical flame.

8. A stage monitor comprising:
a cylindrical frame;
at least one speaker mounted in the cylindrical frame;
at least one electronic component coupled to the cylindrical frame;
mounting holes configured to stand the cylindrical frame above a ground surface;
a grill coupled to a top of the cylindrical frame; and
a plug coupled to the cylindrical frame and the at least one speaker.

9. The stage monitor of claim 1 wherein the at least one speaker further comprises a woofer and a tweeter.

10. The stage monitor of claim 1 wherein the at least one electronic component further comprises a crossover.

11. The stage monitor of claim 1 wherein the at least one electronic component further comprises an amplifier.

12. The stage monitor of claim 1 wherein the at least one electronic component further comprises an equalizer.

13. The stage monitor of claim 1 wherein the at least one electronic component further comprises a switch.

14. The stage monitor of claim 1 further comprising a plurality of mounts on an outside surface of the cylindrical frame configured to mount a grill on the cylindrical frame.

15. A method comprising:
assembling a stand having Cooris compatible bonding brackets to a cylindrically shaped stage monitor;
plugging a wire into the cylindrically shaped stage monitor; and
setting a cylindrically shaped monitor near an area where a musician will play music.

16. The method of claim 15 further comprising adjusting the performance of an electronic component in the cylindrical assembly.

17. The method of claim 15 further comprising placing the cylindrical monitor proximate to drum set.

18. The method of claim 15 further comprising coupling an amplifier to the stage monitor.

19. The method of claim 15 further comprising coupling an electrical pick-up to the stage monitor.

20. The method of claim 15 further comprising coupling a microphone to the stage monitor.
